(19) United States
(12) Patent Application Publication
(10) Pub. No.: US 2009/0202287 A1
(43) Pub. Date: Aug. 13, 2009

(54) Wrist pen

(76) Inventor: Mike J. Katsanevas, Salt Lake City, UT (US)

Correspondence Address: BRYAN J RUFFNER, 8802 BURBANK RD, ANNANDALE, VA, 22003-3854, US

(21) Appl. No.: 12/386,307

(22) Filed: Apr. 16, 2009

Related U.S. Application Data
(63) Continuation-in-part of application No. 11/879,063, filed on Jul. 16, 2007, now abandoned.
Application No. 11/879,063 is a continuation-in-part of application No. 11/115,580, filed on Apr. 28, 2005, now abandoned.
Application No. 11/115,580 is a continuation-in-part of application No. 10/349,789, filed on Jan. 24, 2003, now abandoned.

(51) Int. Cl. B43K 23/00

(52) U.S. Cl. 401/131

(57) ABSTRACT

A wrist pen comprising a wristband stretchable coil sized to fit over the writing hand and secure a writing instrument to the wrist for convenient storage, while freeing of the hands in a storage mode, and stretched for grasping for use in a writing mode to extend the writing tip of the writing instrument between the writing digits in a variety of positions for writing.

### RELATED APPLICATIONS

This patent application is a continuation-in-part of the continuation-in-part patent application filed Jul. 16, 2007, Ser. No. 11/879,063 entitled “Wrist Pen”, which is a continuation-in-part of the continuation-in-part patent application filed Apr. 28, 2005, Ser. No. 11/115,580 entitled “Wrist Pen”, which is a continuation-in-part of the patent application filed Jan. 24, 2003, Ser. No. 10/349,789 entitled “Wrist Pen”, which is a continuation-in-part of the provisional patent application filed Jan. 22, 2002 entitled “Wrist Pen” having Ser. No. 60/349,627.

### BACKGROUND OF THE INVENTION

1. Field of Invention

The present invention relates to writing instruments. In particular, it relates to a wristband attached pen, which provides a readily stored and accessible writing instrument.

2. Description of Related Art

Various pens with holders are known. A. W. Hunt, U.S. Pat. No. 3,503,546 issued Mar. 8, 1968 discloses a writing instrument holder comprising a flexible band adapted to mount on a person's hand and means for holding a writing implement mounted on the band for limited pivotal movement about two axes whereby the writing implement can be selectively pivoted to an out-of-the-way position or to a position for writing. Fortenberry, U.S. Pat. No. 4,148,424, issued Apr. 10, 1979 discloses a holder for a writing instrument comprising a band adapted to completely encircle the person's hand about the palm area A portion of the band is formed into a loop to define a writing instrument receptacle adapted to hold a writing instrument along the forefinger to pivot the pen in position for writing, or out of the way for storage. Sison, U.S. Pat. No. 5,542,588 issued Aug. 6, 1996 discloses a an adjustable pen holder which includes a lightweight strap loosely wrapped around the user's thumb and palm to provide stability and an adjustable support for a writing implement holder, into which a pen is inserted for writing. Gronlund, U.S. Pat. No. 1,455,879 issued May 22, 1923 discloses a pen suspended from a neck lanyard. Green, U.S. Pat. No. 2,866,440 issued Dec. 30, 1958 discloses a wrist strap pen positioning writing guide to train a user proper penmanship positioning.

Cox, U.S. Des. No. 256,292 issued Aug. 12, 1980 discloses an ornamental wristband penholder. Calkins, U.S. Re. 28,289 Dec. 31, 1974 discloses a penholder attachment devise with a sheath, which may be fastened around the wrist. Liu, U.S. Pat. No. 5,584,195 issued Dec. 17, 1996 discloses a flexible decorative bracelet pen, which wraps about the wrist for pen storage when not in use, and when straightened may be used as a writing instrument.

Cited for general interested is Ramos Jr., U.S. Pat. Nos. 4,760,715 issued 4,760,715, which discloses a wristband with a fastener ring to hold a watch or other desired items. Brennen, U.S. Pat. No. 3,294,299, issued Dec. 27, 1966, discloses a wrist safety strap with an end adapted to secure to various objects for carrying. Caluori, U.S. Pat. No. 6,109,490, issued Aug. 29, 2000 discloses a wrist mounted whistle. Schwemberger, U.S. Pat. No. 4,489,862 discloses an armband carrying device worn on the user's arm or wrist, which has a short strap which carries a small item for occasional use, such as a key. Plate, U.S. Pat. No. 5,743,450 issued Apr. 28, 1998 discloses a scissors retaining apparatus, which may be attached about the wrist to prevent the scissors from being dropped. The CoolCoil™ flex band with key ring sold by MMF Industries of Wheeling, Ill. 60090, and the Wrist Coil with key ring produced by Custom Accessories, Inc. of Niles, Ill. 60714 disclose devices which keeps personal items, such as keys within quick access near the wrist. Pens on a Rope sold by the Williams Group on-line at sales@wmsgroup.com provide a pen attached to a necklace worn about the neck. Handi-Writer™ sold by HandiThings, P.O. Box 41, New Melle, Mo. 673365 at orders@handithings.com comprises two stretch bands, one secured about the wrist and another attached thereto and positioned above the wrist to pass over a pen or pencil to hold it in the proper position to teach children the proper writing pen position. Writing Rosella™ sold by the Therapytoys shop at http://www.thereapytoyshop.com/pencil.html provides a wrist assisted writing instrument to hold a pen in position for those having difficulty gripping a pen.

The present invention described below provides a coiled wristband, which has a pen attached and dangled for storage, but which may be extended and held in the hand in a variety of positions for writing.

### SUMMARY OF THE INVENTION

The present invention comprises a stretchable expandable and contractible elastic wristband with a pen, pencil, or other writing instrument attached. It is worn about the wrist for convenient storage when not in use. To use the writing instrument, the wristband is stretched such that the writing instrument fits between the writing digits of the hand in a variety of positions to accommodate different writing styles. For instance, generally the writing instrument is held between the thumb, forefinger, and middle finger. Others hold the writing instrument between the thumb, middle finger and ring finger. While others with more limited dexterity hold the writing instrument in the palm of the hand. The device thus allows a user to write via any number of gripping positions to provide a writing system to meet the writing needs of a variety of users, particularly the handicapped with limited gripping capabilities for writing. After use, the writing instrument is released and returns to its original position to dangle about the wrist until used the next time. This is particularly of use to those bedridden who cannot get up to retrieve a dropped writing instrument. It also meets the needs of those working in conditions where the hands are dirty or greasy, making it difficult to store a writing instrument on one's clothing without smearing them.

The preferred embodiment of the wrist pen consists of an expandable and contractibly coiled spring wristband designed to slip over the wrist. The wristband is preferably made of a plastic or nylon coil, which acts like a spring.

In another preferred embodiment, the coiled wrist band has an extension segment with an attachment ring affixed to attach to the barrel of a writing instrument. In another preferred embodiment, the wristband has two ends, with the writing instrument end opposite the writing tip of attached to a straight segment of a coiled wristband having a key ring or snap clip fastener attached to its other end, such that the band is adapted to fold over itself to form a wrist loop. The wrist loop is then secured by a clip, fastener, or knot in the wristband to leave a short extendable segment attached to the pen making it easier to extend from the wristband and position the writing instrument between the writing digits of the hand by minimizing pulling tension from the band segment to aid in writing. This embodiment has the advantage of allowing a user to size the wristband loop so that it can be worn more comfortably without overly constricting the wrist. The short spring straight segment thus allows the writing instrument to be more readily extended for use and then contracts to move it out of the way of the hand. Keys or other small items may be attached to the key ring.

Another preferred embodiment variation has the writing instrument attached directly to the coiled wristband without a ring.

Preferably, the pen or writing instrument has a barrel sized long enough to be gripped by the fingers of the hand, but short enough to minimize band stretching which interferes with handwriting.

The invention is also used in the restaurant, fast foods, and other industries requiring use of the hands and frequent access to a pen or writing instrument. It provides a writing instrument retractably attached to the wrist for convenient storage and the freeing of the hands. The present invention thus avoids the need to continually locate a writing instrument by providing easy storage and access to a writing instrument, while freeing the hands when the writing instrument is not in use for other purposes.

### DESCRIPTION OF THE DRAWINGS

FIG. 1 is a perspective view of a preferred embodiment of the invention.

FIG. 2a is a perspective view of another embodiment of the invention.

FIG. 2b is another perspective view of the embodiment shown in FIG. 2a

FIG. 3 is a perspective view of another embodiment of the invention.

FIG. 4 is a perspective view of another preferred embodiment of the invention with the pen held on the wrist.

FIG. 5 is a perspective view of the embodiment of FIG. 4 with the pen secured for writing.

### DESCRIPTION OF THE ILLUSTRATED EMBODIMENTS

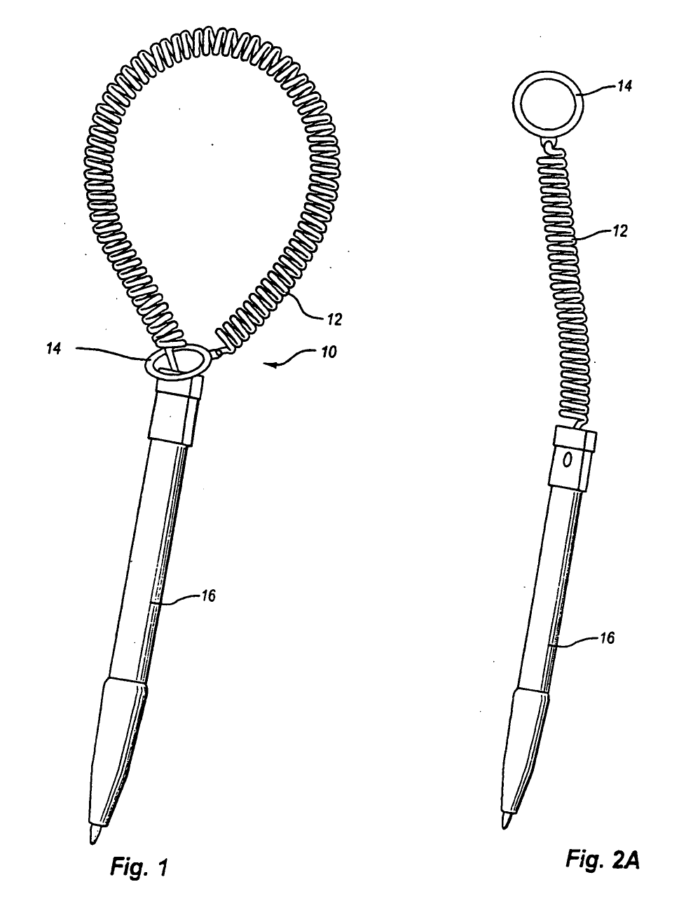

FIG. 1 is a perspective view of a preferred embodiment of the invention 10. The wrist pen 10 shown in FIG. 1 consists of an expandable and contractible coil wristband 12 designed to slip over the wrist. The wristband 12 is preferably made of a plastic, metal, or nylon coil, which acts like a spring to provide tension, but not overly constrict the wrist. It must be extendable in a manner, which does not overly pull on the pen to interfere with writing. It has a ring 14 attached and adapted to attach to the end of a pen 16, leaving the writing tip exposed. Although a pen 16 is shown, other writing instruments may also be readily incorporated.

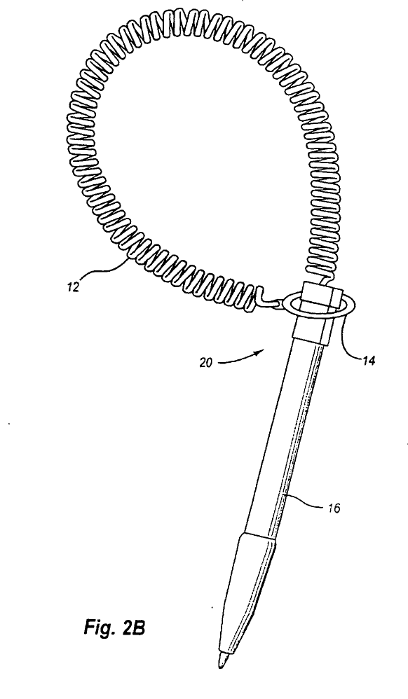

FIG. 2a is another preferred embodiment of a pen 16 attached to a coil wristband 12 adapted to fold over itself to form a loop secured by a clip 18 or not to leave a short spring segment 20 attached to the pen 16. This embodiment allows the user to size the wristband 12 so that it can be worn comfortably without overly constricting the wrist. The short segment 20 allows the pen to be extended for use and then contracts to move the pen out of the way of the hand. Keys may be attached to the ring 14.

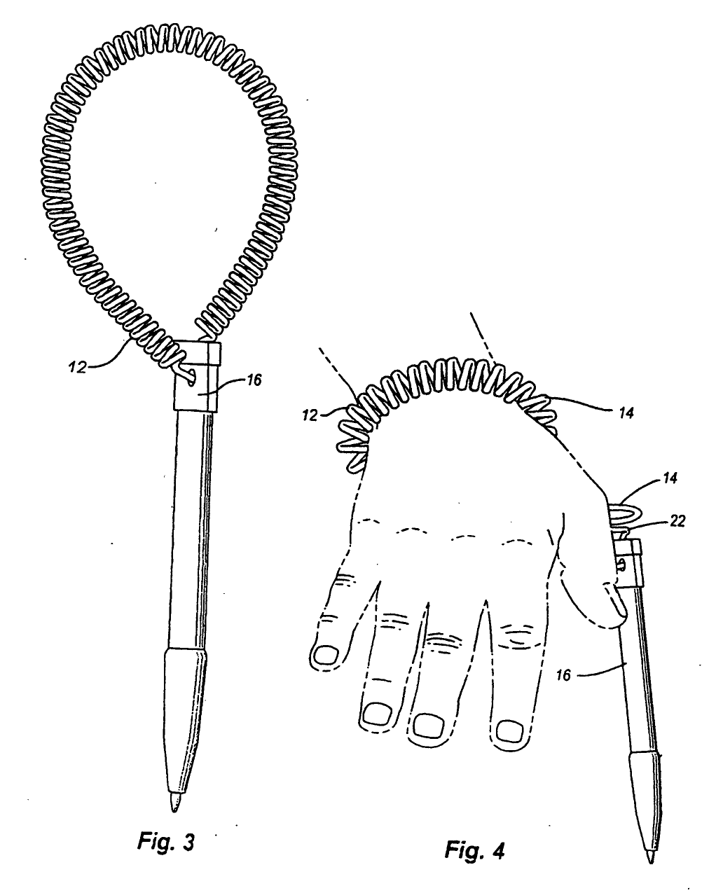

FIG. 3 is another variation where the pen 16 is affixed directly to the ends of the coil to form the wristband 12 without employing a ring attachment.

FIG. 4 is a perspective view of another preferred embodiment of the invention illustrating how a short dangling chord segment 22 may be attached to the short spring segment 24 attached to the coiled wristband 12 to position the pen alongside the writing hand for ease in gripping. An optional key ring 14 is shown attached between the wristband 12 and the short chord segment 22.

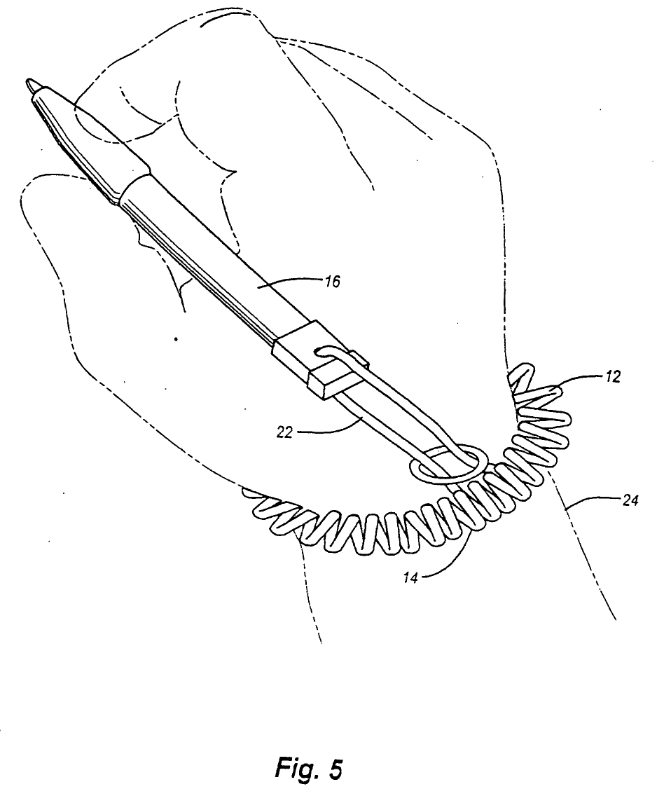

FIG. 5 is a perspective view of the embodiment of FIG. 4 with the pen 16 secured for writing.

This invention 10 is used primarily to provide a pen attached to a wrist for storage when not in use as shown. It may also include a ring 14 to secure keys and other small items to the wristband 12.

The above description and specification should not be construed as limiting the scope of the claims. The claims themselves recite those features deemed essential to the invention

I claim:

1. A wrist pen comprising:
a. an expandable contractible elastic wristband sized to expand to fit over the hand and contract to fit about the wrist,
b. a substantially flexible, non-resilient short segment with first and second ends, such that the first end is attached to the elastic wristband, and
c. a writing instrument with a writing tip and barrel long enough to be gripped by the fingers for writing attached to the second end of the short segment, the. short segment being sufficiently limp and of a length which allows the writing instrument to freely swing from the wristband into position either underneath the palm or over the thumb, wherein the short segment allows a user to selectively hold the writing instrument in various writing positions without the short segment restricting the various writing positions, and wherein the short segment allows the writing instrument when released by the fingers to limply dangle from the wristband in a storage mode.

2. A wrist pen according to claim 10, including removable securing means associated with the writing instrument and wristband, such that the writing instrument may be removably held against the wristband for storage, and then removed to allow the writing instrument to swing into position for grasping by the hand for writing.

3. A wrist pen according to claim 1, wherein the expandable contractible wristband is constructed of a plastic or nylon spring coil.

4. A wrist pen according to claim 3, wherein the short segment is constructed of a plastic or nylon spring coil.

5. A wrist pen comprising:
an elastic wristband adapted to expand over a hand of a user and contract to fit around a wrist of the user;
a writing instrument with a writing tip, the writing instrument being adapted to be gripped in any desired manner or orientation by the hand of the user to enable the user to write with the writing instrument in various writing positions;
a short segment adapted to attach the writing instrument to the elastic wristband, the short segment being substantially flexible, generally non-resilient, and of a length to allow the writing instrument to freely swing from the wristband into the hand of the user to enable the user to selectively hold the writing instrument in various writing positions without the short segment restricting the various writing positions, and wherein the short segment allows the writing instrument when released by the hand of the user to limply dangle from the wristband; and
means for securing the writing instrument to the wristband when the writing instrument in not in use, wherein the means for securing is adapted to selectively hold the writing instrument against the wristband for storage such that the writing instrument does not freely dangle from the wristband when not in use.
